(19) United States
(12) Patent Application Publication
(10) Pub. No.: US 2020/0369113 A1
(43) Pub. Date: Nov. 26, 2020

(54) VEHICLE CABIN THERMAL MANAGEMENT SYSTEMS AND METHODS

(71) Applicant: Ford Global Technologies, LLC, Dearborn, MI (US)

(72) Inventors: Rohan SHRIVASTAVA, Livonia, MI (US); Alin STAN, Warren, MI (US)

(21) Appl. No.: 16/420,575

(22) Filed: May 23, 2019

(51) Int. Cl. B60H 1/00

(52) U.S. Cl. CPC B60H 1/00657; B60H 1/00392; B60H 1/00007; B60H 1/00257; B60H 1/00428; B60H 1/00735; B60H 1/00778; B60H 1/00878; B60H 1/00792; B60H 1/00978; B60H 1/00642

(57) ABSTRACT

A vehicle includes a climate control system to thermally precondition a passenger cabin and a controller programmed to obtain a vicinity temperature from a vehicle sensor and receive location temperature data from a remote source. The controller is also programmed to activate the climate control system in advance of an upcoming trip and to set a first precondition criteria based on the vicinity temperature when the vicinity temperature is within a threshold range of the location temperature data. The controller is further programmed to set a second precondition criteria based on the location temperature data when the vicinity temperature is outside of the threshold range.

### TECHNICAL FIELD

This application is related to conditioning the temperature of a vehicle cabin.

### BACKGROUND

Electrified vehicles may include a rechargeable high-voltage battery to provide power to the propulsion system as well as other vehicle systems. In cases where the battery is recharged using power from the electrical grid, the other vehicle system may rely on power from the grid as opposed to draining battery power. Also, such vehicles may be connected to a network and receive information about scheduled user events that affect an expected conclusion of a charge procedure.

### SUMMARY

A vehicle includes a climate control system to thermally precondition a passenger cabin and a controller programmed to obtain a vicinity temperature from a vehicle sensor and receive location temperature data from a remote source. The controller is also programmed to activate the climate control system in advance of an upcoming trip and to set a first precondition criteria based on the vicinity temperature when the vicinity temperature is within a threshold range of the location temperature data. The controller is further programmed to set a second precondition criteria based on the location temperature data when the vicinity temperature is outside of the threshold range.

A method of thermally preconditioning a vehicle includes receiving information indicative of an upcoming trip, sensing a vicinity temperature from a vehicle sensor, and receiving location temperature data from a remote source. The method also includes activating a climate control system to precondition a cabin in advance of the upcoming trip. The method further includes setting a first precondition criteria based on the vicinity temperature when the vicinity temperature is within a threshold range of the location temperature data, and setting a second precondition criteria based on the location temperature data when the vicinity temperature is outside of the threshold range.

A vehicle includes a climate control system to thermally precondition a passenger cabin, a sensor to output a vicinity temperature, and a transceiver to receive location temperature data from a remote source. The vehicle also includes a controller programmed to activate the climate control system in advance of an upcoming trip. The controller is also programmed to achieve a first precondition start time based on the vicinity temperature when the vicinity temperature is within a threshold range of the location temperature data, and to achieve a second precondition start time based on the location temperature data when the vicinity temperature is outside of the threshold range.

### BRIEF DESCRIPTION OF THE DRAWINGS

FIG. 1 is a schematic of a vehicle having an electrified propulsion system.

FIG. 2 is a flowchart of a method of thermally managing a vehicle cabin.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The ambient air temperature (AAT) is a key input in running the major functions in a vehicle such as passenger cabin heating and/or cooling. An ambient air temperature sensor outputs temperature data indicative of the external environment of the vehicle to accurately calculate thermal loads. Also, passenger cabin thermal preconditioning may be performed on a plugin hybrid vehicle while the vehicle is plugged in for recharging, in advance of an upcoming trip, to efficiently utilize power provided by the external recharging power source. The temperature signal output from the vehicle temperature sensor may be used as a basis to determine the required degree of thermal preconditioning to achieve a desired cabin temperature. In cases when a vehicle is plugged in for recharging while parked in a temperature-controlled garage, the vehicle temperature sensor outputs the indoor temperature of the garage. As a result, any thermal preconditioning of the cabin is performed based on the measured indoor climate. However, the controlled temperature within the garage may be vastly different from the true ambient temperature outside in which the vehicle will be operated. Thus, the passenger cabin may be thermally conditioned based on temp data that is not reflective of the actual environment in which the vehicle will be driven.

Once the vehicle is driven outside of the garage, thermal conditioning inputs are changed based on the outdoor temperature now measured by the sensor, and the cabin thermal conditioning is updated based on the new sensor data. This delayed conditioning of cabin temperature based on the true ambient temperature may unnecessarily drain battery power and reduce the range of the hybrid vehicle.

The ambient air temperature sensor is packaged in a configuration that it is exposed to airflow to accurately measure air temperature. A location exposed to such airflow may cause the sensor to become more susceptible to damage. In some examples, one or more temperature sensors may be disposed at side rearview mirror, near a front grill, or other exposed location. If the temperature sensor on the vehicle is affected by fault condition, for example due to damage, then preconditioning of the cabin may be cancelled.

The vehicle may wireless connectivity to external network, or the “cloud.” As a result, the vehicle may be configured to communicate with a remote weather information source and access to local temperature. Ambient temperature data may be provided to a wireless communication module inside the vehicle and passed to other vehicle modules that control functions that are dependent on external temperature. The temperature data received from the remote weather information source may be compared to the temperature data output from the vehicle temperature sensor. Therefore, control modules operating the climate control system can anticipate the actual need of cooling or heating by comparing the two temperature readings and more effectively control the system. In this way thermal management of the vehicle based on an inferred ambient temperature from the cloud or a smart device. The temperature data from the remote source may supplement the vehicle sensor data. In other cases, thermally preconditioning the cabin may include supplanting the data output from the vehicle temperature sensor in lieu of the remote data. Data transmitted from the remote weather information source may be used for thermal control both under normal driving conditions, as well as for system protection and sensor failure mode responses.

Aspects of the present disclosure include efficiently using power provided by an external power source to accurately thermally condition the cabin and thus enhance the maximum driving range of the electrified vehicles. Rather than conditioning the cabin using battery power once driving has begun, power from the external power source is used to condition the cabin based on anticipating the upcoming need for thermal management. This allows for the reservation of more battery power for driving. According to some examples, the climate control system is activated in advance of an upcoming trip during a battery recharge procedure. In alternative examples, if the battery stores sufficient power greater than a threshold, thermal preconditioning in advance of the upcoming trip may be performed even when the vehicle is not recharging.

Since the vehicle is already equipped with a wireless communication module for telematics and other purposes, there is no need for additional hardware to the system. Additional aspects of the present disclosure include using data transmitted from the remote weather information source for system control in lieu of vehicle sensor signals in response to a vehicle temperature sensor fault condition.

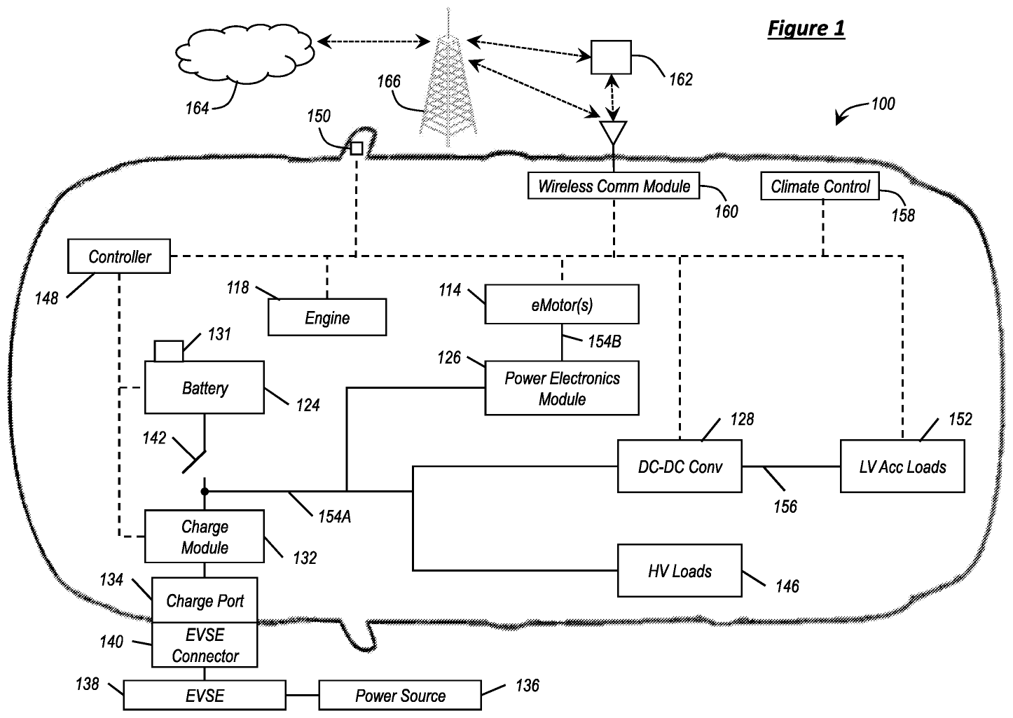

FIG. 1 depicts a plug-in hybrid-electric vehicle (PHEV) 100. The PHEV 100 includes an electrified propulsion system having one or more electric machines 114 mechanically coupled to a hybrid transmission (not shown). Each of the electric machines 114 may be capable of operating either as a motor or as a generator. In addition, the hybrid transmission is mechanically coupled to an internal combustion engine 118. The electric machines 114 are arranged to provide propulsion torque as well as deceleration torque capability either while the engine 118 is operated or turned off. The electric machines 114 are capable of operating as generators to provide fuel economy benefits by recovering energy that would normally be lost as heat in a friction braking system. The electric machines 114 may additionally impart a reaction torque against the engine output torque to generate electricity for recharging a traction battery the while the vehicle is operating. The electric machines 114 may further reduce vehicle emissions by allowing the engine 118 to operate near the most efficient speed and torque ranges. When the engine 118 is off, the PHEV 100 may be operated in an electric-only drive mode using the electric machines 114 as the sole source of propulsion. The hybrid transmission is also mechanically coupled to road wheels to output torque from the electric machines 114 and/or combustion engine 118. While the topology of hybrid vehicle 100 is provided by way of example, aspects of the present disclosure may be applicable to any vehicle having an electrified propulsion system. Specifically, any electrified vehicle capable of receiving power from a power grid, such as battery electric vehicles (BEV's), may benefit from the thermal preconditioning systems and methods of the present disclosure.

A rechargeable battery or battery pack 124 stores energy that can be used to power the electric machines 114. The battery pack 124 typically provides a high-voltage direct current (DC) output from one or more battery cell arrays, sometimes referred to as battery cell stacks, within the traction battery 124. Each battery cell array may include one or more battery cells. The battery cells, such as a prismatic, pouch, cylindrical, or other types of cells, are used to convert stored chemical energy to electrical energy. The cells may include a housing, a positive electrode (cathode) and a negative electrode (anode). An electrolyte allows ions to move between an anode and cathode during discharge, and then return during recharge. Terminals may allow current to flow out of the cell for use by the vehicle. Different battery pack configurations may be available to address individual vehicle variables including packaging constraints and power requirements. Discussed in more detail below, the battery cells may be thermally regulated by a thermal-management system. Examples of thermal-management systems include air cooling systems, liquid cooling systems and a combination of air and liquid systems.

One or more contactors 142 may selectively isolate the traction battery 124 from a DC high-voltage bus 154A when opened and couple the traction battery 124 to the DC high-voltage bus 154A when closed. The traction battery 124 is electrically coupled to one or more power electronics modules 126 via the DC high-voltage bus 154A. The power electronics module 126 is also electrically coupled to the electric machines 114 and provides the ability to bi-directionally transfer energy between AC high-voltage bus 154B and the electric machines 114. According to some examples, the traction battery 124 may provide a DC current while the electric machines 114 operate using a three-phase alternating current (AC). The power electronics module 126 may convert the DC current to a three-phase AC current to operate the electric machines 114. In a regenerative mode, the power electronics module 126 may convert the three-phase AC current output from the electric machines 114 acting as generators to DC current compatible with the traction battery 124. The description herein is equally applicable to an all-electric vehicle without a combustion engine.

In addition to providing energy for propulsion, the traction battery 124 may provide energy for other vehicle electrical systems. The vehicle 100 may include a DC/DC converter module 128 that is electrically coupled to the high-voltage bus 154. The DC/DC converter module 128 may be electrically coupled to a low-voltage bus 156. The DC/DC converter module 128 may convert the high-voltage DC output of the traction battery 124 to a low-voltage DC supply that is compatible with low-voltage vehicle loads 152. The low-voltage bus 156 may be electrically coupled to an auxiliary battery 130 (e.g., a 12-volt battery). The low-voltage loads 152 may be electrically coupled to the low-voltage bus 156. The low-voltage loads 152 may include various controllers within the vehicle 100.

The traction battery 124 of vehicle 100 may be recharged by an off-board power source 136. The off-board power source 136 may be a connection to an electrical outlet. The external power source 136 may be electrically coupled to a charging station or another type of electric vehicle supply equipment (EVSE) 138. The off-board power source 136 may also be an electrical power distribution network or grid as provided by an electric utility company. The EVSE 138 provides circuitry and controls to regulate and manage the transfer of energy between the power source 136 and the vehicle 100. The off-board power source 136 may provide DC or AC electric power to the EVSE 138. The EVSE 138 includes a charge connector 140 for plugging into a charge port 134 of the vehicle 100. The charge port 134 may be any type of port configured to transfer power from the EVSE 138 to the vehicle 100. The charge port 134 may be electrically coupled to a charge module or on-board power conversion module 132. The power conversion module 132 conditions power supplied from the EVSE 138 to provide the proper voltage and current levels to the traction battery 124. The power conversion module 132 interfaces with the EVSE 138 to coordinate the delivery of power to the vehicle 100. The EVSE connector 140 may have pins that mate with corresponding recesses of the charge port 134. Alternatively, various components described as being electrically coupled or connected may transfer power using wireless inductive coupling or other non-contact power transfer mechanisms. The charge components including the charge port 134, power conversion module 132, power electronics module 126, and DC-DC converter module 128 may collectively be considered part of a power interface system configured to receive power from the off-board power source 136.

When the vehicle 100 is plugged in to the EVSE 138, the contactors 142 may be in a closed state so that the traction battery 124 is coupled to the high-voltage bus 154 and to the power source 136 to charge the battery. The vehicle may be in the ignition-off condition when plugged in to the EVSE 138.

The traction battery 124 may also have one or more temperature sensors 131 such as thermistors or other types of temperature sensors. The temperature sensor 131 may be in communication with the controller 148 to provide data indicative of temperature of the battery cells. The vehicle 100 may also include temperature sensor 150 to provide data indicative of ambient air temperature. In the example schematic of FIG. 1, the temperature sensor 150 is disposed in a vehicle side mirror, but it should be appreciated that the temperature sensor may be located anywhere on the vehicle suitable to detect ambient temperature.

One or more high-voltage electrical loads 146 may be coupled to the high-voltage bus 154. The high-voltage electrical loads 146 may have an associated controller that operates and controls the high-voltage electrical loads 146 when appropriate. The high-voltage loads 146 may include compressors and electric heaters related to the vehicle climate control system 158. For example, the vehicle climate control system may draw high-voltage loads in the range of 6 kW-11 kW under high cooling loads. According to some examples, the rechargeable battery 124 supplies powers at least a portion of the climate control system 158.

The vehicle 100 further includes at least one wireless communication module 160 configured to communicate with external devices. over a wireless network. According to some examples, wireless communication module includes a BLUETOOTH transceiver to communicate with a user's remote device 162 (e.g., cell phone, smart phone, PDA, or any other device having wireless remote network connectivity). The remote device 162 can in turn be used to communicate with a network 164 outside the vehicle 100 through, for example, communication with a cellular tower 166. In some examples, tower 166 may be a WiFi access point.

Data may be communicated between the wireless communication module 160 and a remote network utilizing, for example, a data-plan, data over voice, or DTMF tones associated with the remote device 162. Alternatively, the wireless communication module 160 may include an onboard modem having antenna in order to exchange data with the network 164 over the voice band. According to some examples, the controller 148 is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In further example, remote device 162 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can utilize the entire bandwidth. Further data transfer protocols may also be suitable according to aspects of the present disclosure, for example, such as Code Domain Multiple Access (CDMA), Time Domain Multiple Access (TDMA), and Space-Domain Multiple Access (SDMA) for digital cellular communication.

The various components discussed may have one or more associated controllers to control, monitor, and coordinate the operation of the components. The controllers may communicate via a serial bus (e.g., Controller Area Network (CAN)) or via discrete conductors. In addition, a vehicle system controller 148 may be provided to coordinate the operation of the various components.

System controller 148, although represented as a single controller, may be implemented as one or more controllers. The controller 148 may monitor operating conditions of various vehicle systems. According to the example of FIG. 1, at least the electric machines 114, engine 118, traction battery 124, DC-DC converter 128, charging module 132, and high-voltage loads 146, low-voltage loads 152, and vision system 158 are in communication with the controller 148.

The controller 148 also generally includes any number of subcomponents such as microprocessors, ASICs, ICs, memory (e.g., FLASH, ROM, RAM, EPROM and/or EEPROM) and software code to co-act with one another to perform various operations. The subcomponents allow onboard processing of commands and execute any number of predetermined routines according to a desired timing or alternatively in response to one or more inputs received from vehicle systems. The processors may be coupled to non-persistent storage and/or persistent storage. In an example configuration, the non-persistent storage is RAM, and the persistent storage is flash memory. In general, persistent (non-transitory) storage can include all forms of storage that maintain data when a computer or other device is powered down. The controller 148 may also store predetermined data within the memory, such as “look up tables” that are based on calculations and/or test data. The controller communicates with other vehicle systems and sub-controllers over one or more wired or wireless vehicle connections and may use common bus protocols (e.g., CAN and LIN). Used herein, references to “a controller” refer to one or more controllers.

The traction battery 124 includes a current sensor to output a signal indicative of a magnitude and direction of current flowing into or out of the traction battery 124. The traction battery 124 also includes a voltage sensor to sense a voltage across terminals of the traction battery 124. The voltage sensor outputs a signal indicative of the voltage across the terminals of the traction battery 124. The traction battery 124 may also have one or more temperature sensors 131 such as thermistors or other types of temperature sensors. The temperature sensor 131 may be in communication with the controller 148 to provide data indicative of temperature of the battery cells.

The current sensor, voltage sensor, and temperature sensor outputs of the traction battery 124 are all provided to the controller 148. The controller 148 may be programmed to compute a state of charge (SOC) based on the signals from the current sensor and the voltage sensor of the traction battery 124. Various techniques may be utilized to compute the state of charge. For example, an ampere-hour integration may be implemented in which the current through the traction battery 124 is integrated over time. The SOC may also be estimated based on the output of the traction battery voltage sensor 104. The specific technique utilized may depend upon the chemical composition and characteristics of the particular battery.

A desired temperature operating range may also be specified for the traction battery. The temperature operating range may define upper and lower thermal limits within which the battery 124 is operated. In response to a sensed temperature approaching a thermal limit, operation of the traction battery 124 may be modified or other mitigation actions may be initiated to actively regulate temperature. According to some example configurations, the traction battery 124 as well as other vehicle components are thermally regulated with one or more thermal-management systems.

Discussed in more detail below, the climate control system 158 may be operated based on one or more algorithms stored at the controller 148. According to some examples, the climate control system 158 is operated prior to vehicle departure from a charging station in order to thermally precondition the passenger cabin for optimal operation and/or passenger comfort. In a specific example the controller 148 is programmed to issue a command to operate the climate control system 158 based on a signal received from the temperature sensor 150. In order to avoid unnecessarily draining power from the battery 124, the temperature preconditioning may be performed while the vehicle 100 is recharging and plugged into power source 136. In alternative examples, either limited or full temperature preconditioning may be permitted when the battery state of charge is greater than a threshold.

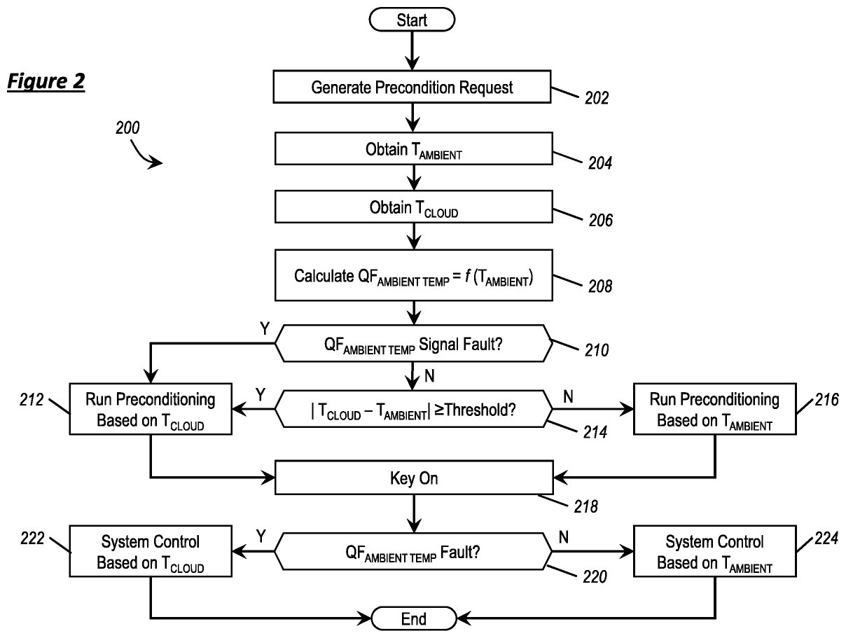

Referring to FIG. 2, a flowchart 200 represents an algorithm for a method of preconditioning vehicle temperature may be based on temperature obtained from a remote source. At step 202 the algorithm includes generating a temperature preconditioning request. The temperature preconditioning may be based on data indicative of the timing of an upcoming trip. In some examples a remote request may be transmitted to the vehicle indicating the timing of an upcoming trip. In one more specific example, a predetermined timing of an upcoming trip is based on an ongoing schedule such as when a driver goes to and/or from work. In another specific example, a predetermined timing of an upcoming trip is based on a user reservation of a shared vehicle for a particular time. In further examples, information indicative of the upcoming drive is received from a user mobile device. In additional further examples, a user inputs desired climate settings and planned trip time to a mobile app, which is then conveyed to the vehicle. In this way, the controller may be programmed to receive information indicative of an upcoming drive and generate a thermal preconditioning command in sufficient time to achieve a target cabin temperature by the expected start of the upcoming drive.

At step 204 the algorithm includes obtaining a local ambient temperature within a vicinity of the vehicle T_{AMBIENT}. As discussed above, the vehicle includes one or more temperature sensors to provide a signal indicative of the exterior temperature near the vehicle. Based on the location of the vehicle, the vehicle vicinity temperature T_{AMBIENT} may be reflective of an outdoor temperature, which can be affected by seasonal changes and weather. In other cases, the vehicle vicinity temperature T_{AMBIENT} may be reflective of an indoor temperature, which can include climate-controlled conditions dependent on the particular location.

At step 206 the algorithm includes obtaining a general ambient temperature T_{CLOUD} associated with the geographical location of the vehicle. Temperature data may be received from a remote weather information source. In some examples, T_{CLOUD} may be obtained from a remote source, for example from a weather service via network communications. In other examples, temperature data may be provided applications that reside on any computing device such as a user mobile device, a computer, tablet, smart watch, smartphone, and computing devices residing in other vehicles. As discussed above, the vehicle is equipped with a wireless communication module and may exchange data over a network using cellular communication, WiFi, or any other suitable wireless communication protocol.

At step 208 the algorithm includes calculating a quality factor of the ambient temperature QF_{AMBIENT TEMP} based on the value T_{AMBIENT}. QF_{AMBIENT TEMP} provides an assessment of the signal quality of the vehicle temperature sensor. That is, factors such as an open circuit, short circuit and signal fluctuations may degrade the temperature signal and thus reduce the quality factor. Moreover, external conditions may also negatively affect signal output even when the sensor is fully functional. For example, in the case of a vehicle sensor located near a front-end grille, factors such as ice buildup or front end damage may impede air flow across the sensor negatively impacting QF_{AMBIENT TEMP}. Based on the value of QF_{AMBIENT TEMP}, it may be indicative of a fault associated with the signal output from the vehicle temperature sensor.

If at step 210 there is a signal fault associated with QF_{AMBIENT TEMP}, the algorithm includes at step 212 conducting preconditioning operations based on T_{CLOUD} and disregarding values provided by the vehicle temperature sensor. In this way, the controller may be programmed to infer that the general ambient temperature T_{CLOUD} received from the remote source is more reliable than the local ambient temperature T_{AMBIENT} received from a vehicle sensor demonstrating a fault condition. In some examples, the controller may be programmed to set a target cabin temperature based on weather data including T_{CLOUD} in response to detecting a fault associated with sensing the vehicle vicinity temperature.

If at step 210 there is no fault detected that is associated with QF_{AMBIENT TEMP}, the algorithm includes at step 214 calculating the absolute value of the difference between the general ambient temperature from the remote source and the local ambient temperature measured by the vehicle sensor. If the difference is greater than a temperature threshold, this difference may indicate that the vehicle is currently in an indoor environment that thermally differs from the outside environment in which the vehicle is about to travel. The controller may be programmed to, in response to |T_{CLOUD}−T_{AMBIENT}| being greater than or equal to a predetermined temperature threshold, disregard T_{AMBIENT} at step 212 and conducting preconditioning operations based on T_{CLOUD} received from the remote source. More specifically, the controller may be programmed to set a precondition criterion based on the location-based temperature data in response to the vicinity temperature being outside of the threshold range of the location-based temperature data.

The precondition criteria can include any of a precondition procedure start time, a target cabin temperature, a blower setting, a high-voltage heater setting, a window venting command, or other suitable actions to thermally influence thermal properties of the cabin.

According to aspects of the present disclosure, the vehicle is better thermally prepared to enter an upcoming driving environment associated with T_{CLOUD}. For example, if the vehicle is charging at an indoor charging station having a climate-controlled environment during hot weather, the indoor temperature, and thus the vehicle's vicinity temperature, may not be representative of the upcoming heat load. That is, thermal preconditioning (e.g., cooling) of the passenger cabin and/or the battery may be initiated in advance of an upcoming trip to take full advantage of the connection to the external grid power source and avoid unnecessary battery drain. The same benefit of improved accuracy of cabin preconditioning may be present during extremely cold weather. That is, according to some examples, the controller may be programmed to pre-heat the vehicle cabin and/or the battery itself to avoid a sudden temperature drop when the vehicle embarks upon driving in the cold weather.

If at step 214 the absolute value of the difference between the general ambient temperature from the remote source and the local ambient temperature measured by the vehicle sensor is less than the predetermined temperature threshold, the value of the local temperature as measured in the vicinity of the vehicle may be deemed sufficiently reliable to inform the control of any required thermal preconditioning. The algorithm includes at step 216 running desired preconditioning based on the local ambient temperature measured by the vehicle sensor. According to some examples, the controller is programmed to, in response to |T_{CLOUD}−T_{AMBIENT}| being less than a predetermined temperature threshold, conduct preconditioning operations based on T_{AMBIENT} measured locally at the vehicle. More specifically, the controller may be programmed to set a precondition criterion based on the vicinity temperature in response to the vicinity temperature being within a threshold range of the location temperature data.

At step 218 the algorithm includes receiving a key on signal according to a driver input or other prompt to start the vehicle. As the vehicle is operated, ongoing thermal management of the passenger cabin and/or battery may still be required based on the desired temperature settings and the true ambient temperature.

If at step 220 there is a signal fault associated with QF_{AMBIENT TEMP} detected, the algorithm includes at step 222 controlling the thermal conditioning of the passenger cabin based on T_{CLOUD} and disregarding values provided by the vehicle temperature sensor. In some alternate examples, the thermal conditioning of the traction battery is also controlled based on recognition of the signal fault and relying on T_{CLOUD} as an input representing the true ambient temperature. Similar to the preconditioning scenario described above, the controller may be programmed to infer that the general ambient temperature T_{CLOUD} received from the remote source is more reliable than the local ambient temperature T_{AMBIENT} received from a vehicle sensor demonstrating a fault condition.

If at step 220 there is no fault detected that is associated with QF_{AMBIENT TEMP}, the algorithm includes at step 224 running ongoing control of the thermal management system based on the local ambient temperature measured by the vehicle sensor. According to some examples, the controller is programmed to, in response to no thermal sensor fault while the vehicle is operated, conditioning the temperature of the passenger cabin based on T_{AMBIENT} measured locally at the vehicle.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a climate control system to thermally precondition a passenger cabin; and
a controller programmed to,
obtain a vicinity temperature from a vehicle sensor,
receive location temperature data from a remote source,
activate the climate control system in advance of an upcoming trip,
set a first precondition criterion based on the vicinity temperature when the vicinity temperature is within a threshold range of the location temperature data, and
set a second precondition criterion based on the location temperature data when the vicinity temperature is outside of the threshold range.

2. The vehicle of claim 1 wherein the first precondition criterion and the second precondition criterion include at least one of: a precondition procedure start time, a target cabin temperature, a blower setting, a heater setting, and a window venting command.

3. The vehicle of claim 1 wherein the controller is further programmed to set the second precondition criteria in response to detecting a fault condition associated with the vehicle sensor.

4. The vehicle of claim 1 further comprising a rechargeable battery wherein the controller is further programmed to, while recharging the battery with grid power, operate the climate control system using the grid power.

5. The vehicle of claim 1 wherein the controller is further programmed to initiate operation of the climate control system in response to a remote request indicating a timing of the upcoming trip.

6. The vehicle of claim 5 wherein the remote request is at least one of data received from a user mobile device and a user reservation of a shared vehicle.

7. The vehicle of claim 1 wherein the controller is further programmed to receive the location temperature data from a user mobile device.

8. A method of thermally preconditioning a vehicle comprising:
receiving information indicative of an upcoming trip;
sensing a vicinity temperature from a vehicle sensor;
receiving location temperature data from a remote source;
activating a climate control system to precondition a cabin in advance of the upcoming trip;
setting a first precondition criterion based on the vicinity temperature when the vicinity temperature is within a threshold range of the location temperature data; and
setting a second precondition criterion based on the location temperature data when the vicinity temperature is outside of the threshold range.

9. The method of claim 8 wherein the first precondition criterion and the second precondition criterion include at least one of: a precondition procedure start time, a target cabin temperature, a blower setting, a heater setting, and a window venting command.

10. The method of claim 8 further comprising setting the second precondition criterion in response to detecting a fault associated with the vehicle sensor.

11. The method of claim 8 wherein activating the climate control system in advance of the upcoming trip is permitted only when a battery state of charge is greater than a threshold.

12. The method of claim 8 wherein activating the climate control system in advance of the upcoming trip is permitted only while the vehicle is recharging with grid power.

13. The method of claim 8 further wherein the remote source is a user mobile device.

14. A vehicle comprising:
a climate control system to thermally precondition a passenger cabin;
a sensor to output a vicinity temperature;
a transceiver to receive location temperature data from a remote source; and
a controller programmed to
activate the climate control system in advance of an upcoming trip,
achieve a first precondition start time based on the vicinity temperature when the vicinity temperature is within a threshold range of the location temperature data, and
achieve a second precondition start time based on the location temperature data when the vicinity temperature is outside of the threshold range.

15. The vehicle of claim 14 wherein the controller is further programmed to set a first precondition target cabin temperature based on the vicinity temperature in response to the vicinity temperature being within a threshold range of the location temperature data, and to set a second precondition target cabin temperature based on the location temperature data in response to the vicinity temperature being outside of the threshold range.

16. The vehicle of claim 14 further comprising a rechargeable battery configured to power at least a portion of the climate control system, wherein the controller is further programmed to activate the climate control system in advance of the upcoming trip during a battery recharge procedure.

17. The vehicle of claim 14 further comprising a rechargeable battery configured to power at least a portion of the climate control system, wherein the controller is further programmed to activate the climate control system in advance of the upcoming trip if a battery state of charge is greater than a threshold.

18. The vehicle of claim 14 wherein the controller is further programmed to receive the location temperature data from a user mobile device.

19. The vehicle of claim 14 wherein the controller is further programmed to receive information indicative of the upcoming trip from a user mobile device.

20. The vehicle of claim 14 wherein the controller is further programmed to receive information indicative of the upcoming trip based on a user reservation of a shared vehicle.
